(19) United States
(12) Patent Application Publication
(10) Pub. No.: US 2012/0237652 A1
(43) Pub. Date: Sep. 20, 2012

(54) PROCESS AND APPARATUS FOR PRODUCING FROZEN CONFECTIONS

(75) Inventors: Johannes IJsbrand Tiesnitsch, Beek Ubbergen (NL); Johannes Cornelis Antonius Martens, Beek Ubbergen (NL)

(73) Assignee: TIESNITSCH BEHEER B.V., Beek Ubbergen (NL)

(21) Appl. No.: 13/322,909

(22) PCT Filed: May 26, 2010
(86) PCT No.: PCT/EP2010/003176

§ 371 Date: May 9, 2012

Related U.S. Application Data
(60) Provisional application No. 61/181,869, filed on May 28, 2009.

(30) Foreign Application Priority Data
May 28, 2009 (EP) 009007114.3

(51) Int. Cl. A23G 9/22; F25C 5/08; F25C 1/00

(52) U.S. Cl. 426/389; 62/340; 62/349

(57) ABSTRACT

Process for producing frozen confections, comprising the steps of a) filling a mould, having a mould bottom, mould walls and an open mold top, with the substance to be frozen; b) freezing said substance into a frozen confection; c) releasing said frozen confection from the mould; characterized in that the mould is filled through at least one opening in the lower part of the mould walls or in the mould bottom and apparatus for producing frozen confections.

The invention relates to a process and apparatus for producing frozen confections.

Such process is known from U.S. Pat. No. 2,123,215. The process applied there comprises filling a mould from the top consecutively with two substances to be frozen.

The known method has as a disadvantage that the filling of the moulds from the top brings about extensive contact of the substance with air. This may cause oxidation, in particular when the substance is a fruit juice. Volatile components, which to a large extent contribute to the flavour and odor of the confection, may escape from the substance. These mechanisms may cause degradation in hygiene, flavour and appearance of the substance to be frozen during the filling process.

Aim of the present invention is to provide a method to produce frozen confections that prevents this degradation of the substance at least to a large extent.

This aim is achieved in that the process for producing frozen confections, comprises the steps of
a. filling a mould, having a mould bottom, mould walls and an open mould top, with the substance to be frozen;
b. freezing said substance into a frozen confection;
c. releasing said frozen confection from the mould;
characterized in that the mould is filled through at least one opening in the lower part of the mould walls or in the mould bottom.

Filling the mould through at least one opening in the lower part of the mould walls or in the mould bottom minimizes contact of the substance with air and thus minimizes the occurrence of the degradation mechanisms that occur in the known process.

Filling the mould through one or more openings in the bottom has the advantage that only small part of the substances comes into contact with the environment, viz. only over their top surface area in the mould.

This embodiment is preferred but filling the mould additionally or only through one or more openings in the lower part of the mould walls is also possible. The lower part of the mould walls is to be understood as the part of the walls extending from the mould bottom over at most 50%, preferably over at most 25% and more preferably over at most 10%, of the height of the walls measured from the bottom to the open end of the moulds. In any case at least one of the openings in the mould wall is positioned below the top level the substance will have after filling the mold. Contact of the substances with the environment may be more extensive in this embodiment, though still significantly reduced compared to the known process. Contact with surrounding air may be even further restricted by applying an inert gas blanket at the open top ends of the mould. The inert gas preferably is nitrogen.

From U.S. Pat. No. 1,900,355 A a process is known to fill moulds by pressing these upside down, i.e. with their bottom up an their open top end down, downwardly into a container containing the substance to be frozen. Thus the moulds are filled through their open top end rather than through an opening in the bottom or in the lower part of the mould walls.

From GB,884, 724 A a process is known to fill a plurality of moulds, the moulds being mounted to the bottom plate of a tray, the open top end of the moulds extending upwardly from the bottom plate of the tray. The walls of the top end are provided with a number of openings. By pouring a substance to be frozen into the tray, the moulds are filled through the openings in the top part of the walls. The openings thus are not present in the lower part of the walls and the substance is extensively exposed to the environment during the filling process.

The opening in the walls or bottom of the mould can be connected to a duct system connected to a common input for the substance to be frozen. This common input may be fed from containers containing the substance to be frozen applying a suitable dosing system. Dosing systems for fluid substances, comprising e.g. pumps, ducts and valves, are known per se and can be used in the process according to the invention.

Preferably the moulds are filled by forcing the substance through the at least one opening in the lower part of the mould walls or in the mould bottom. Forcing is to be understood as applying a force or pressure on the substance rather than only using gravity and hydrostatic pressure for forcing the substance through the openings. Forcing the substance into the moulds has the advantage of decreasing filling time. This decreasing filling time will cause shorter contact times with potential oxygen from the environmental air present in the mould and less loss of volatile components.

Moulds applicable in the process according to the invention have a bottom and walls and an open top end. The bottom is understood to be the part of the mould opposite to the open top end, whereas the walls extend from the bottom to the open top end, the bottom and walls forming a cavity of a desired shape having an open top end. The shape corresponds to the desired shape of the frozen substance.

The mould is filled with an amount of the substance to be frozen. This substance preferably is in fluid form. It may contain small particles like fruit fibers or pulp or particles found in pressed fruit juice. If such particles are present the dimensions of the dosing ducts and the filling openings will be chosen to prevent clogging thereof by the particles. When particles are present, forcing will also have the advantage to prevent clogging or when clogging did occur to induce unclogging. The mould may be filled with one fluid substance or with more than one fluid substance to obtain a mixed multi-substance confection. The total amount corresponds with the desired size of the confection. The substance is frozen then by cooling the mould, e.g. by a cooling substance surrounding the outer side of the mould. It is also possible for the mould to contain cooling liquid ducts through which cooling liquid is flowing. Also other known techniques for freezing from the outside an amount of liquid in a mould can be applied in the process according to the invention. The mould preferably is made of a highly heat conductive material, e.g. a metal.

The substance in the mould thus freezes to a frozen confection consisting of the substance. The resulting frozen confection then is released from the mould. To this end the cooling of the mould will be stopped. To shorten release time and to avoid damage when lifting the frozen confection from the mould in which it has been frozen, it may be advantageous to heat the mold bottom and/or walls for a short time, thus loosening the frozen confection from the mould. To this end heating means, e.g. electric heating wiring or heating fluid ducts may be present in the mould bottom and/or walls.

The form of the mould should be such that by moving a frozen piece in the mould in an upward direction, i.e. in a direction from the bottom to the top end, room between the confection and the mould walls is formed over at least part of the surface of the frozen part in order to prevent a vacuum to occur in a cavity between the frozen part and the mould bottom and to allow air to escape from that cavity when the mould is filled. Preferably the mould is tapered and the area of the cross section of the mould normal to the direction from bottom to open top end increases from bottom to top end. Lifting the frozen confection then creates room everywhere between the confection and the bottom and walls of the mould. More preferably the mould has a conical form.

Preferably a peg is positioned in the mould extending into the substance to be frozen. This peg allows easy removal of the frozen confection and also makes consumption of the confection more comfortable. The peg can be positioned before, during or after the introduction of the substance in the mould. One of the peg's ends will extend into the substance before this is completely frozen.

Preferably in the process according to the invention a number of equal or different moulds are filled at the same time and through the openings in the mould bottoms or walls only. When fill openings are present in the mould walls their position must be below the upper substance level to be reached after filling the moulds. Only in that case the advantages of easy and accurate dosing and achieving equal substance levels in all moulds as described below will be achieved. To the same end the mould bottoms will be positioned in one horizontal plane.

Preferably all moulds are filled from a common substance duct connected to the openings in the mould bottoms or mould walls. This filling of all moulds through one duct increases productivity considerably. Since the openings are in the bottom or in the lower part of the mould walls it also has the advantage of easier and more accurate dosing of the substances to a number of moulds at the same time, with greater accuracy and less difference between the mould fillings. By introducing the preferably fluid substances from the bottom, gravity and hydrostatic pressure guarantee the same surface level of the substance in each mould, so equal amounts of substance in each mould, assumed that all moulds filled in one and the same step are equal as they will be in practice. Preferably the substance is forced into the moulds as described above. Further, the amount of substance to be introduced does not have to be adjusted for each mould separately but only the total amount to fill all the moulds that are filled at the same time. Thus any inaccuracy in this amount will be divided over the total number of moulds, whereas in the known method each mould will have such inaccuracy separately. Also differences in mould volumes will not lead to differences in the filling level between the moulds. Thus the process according to the invention requires less complex dosing installations and equal and accurate filling of all the moulds is easily obtained.

The invention thus further relates to a process for producing frozen confections, comprising the steps of
a. filling a number of moulds at the same time with a substance to be frozen, the moulds having a mould bottom, mould walls and an open mold top;
b. freezing said substance into a frozen confection;
c. releasing said frozen confection from the moulds;
characterized in that the moulds are filled through at least one opening in the lower part of the mould walls or in the mould bottom from a common duct system connecting the at least one openings of all moulds.

The process according to the invention can be used to produce confections from any kind of freezable substances. Examples of these are fruit juices, sherbets, water-ice, ice cream and other edible, tasty water-containing and in general fluid substances. The viscosity of the substances in combination with the dimensions of the dosing system must allow it to be transported from e.g. a storage container to and into the moulds in a desired time by the transport means applied. The skilled person will recognize that the allowable viscosity will depend on e.g. pump capacity, dimension of transport ducts and mould and filling openings dimensions. This allowable viscosity can be established by routine tests in a given equipment. Also the presence of particles in the fluid, as mentioned before, will require adapted equipment.

The invention further relates to an apparatus for producing frozen confections comprising at least one set of moulds each having a mould bottom, mould walls and an open mould top, the mould bottoms being positioned in one plane, the moulds extending from that plane and each mould having at least one fill opening in the lower part of its walls or in its bottom, the at least one opening being connected to a common duct system connectable to common filling means, means for cooling the moulds to form pieces of frozen substance in the moulds, and means for taking pieces of frozen substance from the mould.

In the apparatus the common filling means preferably comprise means for applying pressure on the duct system and means for dosing a desired amount of substance to the at least one set of molds

The apparatus comprises at least one set of moulds. The moulds preferably are made of a highly heat conductive material. Material having a shape memory may have the advantage that release of frozen parts from the mould can be fast and simple, e.g. by applying an electrical voltage or current to the mould. The number of moulds may vary. The larger the number of moulds in a set, the more economical the production of frozen confections as a larger number can be produced in one run. The moulds are constructed as described above, having a bottom, walls and an open mould top allowing frozen contents to be removed from the mould.

The moulds are positioned with respect to each other such that the bottoms of the moulds are lying in one plane. The moulds extend from that plane in a substantially normal direction to that plane. Under production conditions this plane will be positioned horizontally, the open top end of the moulds facing upwards and accordingly the moulds will extend vertically from the bottom plane.

The moulds have at least one fill opening in their bottom part or in the lower part of the walls. The fill openings are connected to a common duct. Rigid or flexible connection pipes running from each opening to the common duct can establish such connection. Preferably these connection pipes are not unnecessary long so as to keep their volume low. This allows filling all the moulds in one run through only one duct. The advantages of accuracy and simplicity of such filling system in practice have been described above in the description of the process and are brought about by the chosen construction of the apparatus.

A further constructional advantage of having the filling system connected to the mould bottom or lower part of the walls, rather than having a system for filling the moulds from the top, resides in that the open top end of the moulds remain accessible for positioning pegs into the mould and for removing the frozen objects from the mould, without having to move or remove a filling system hanging above the moulds first.

The common duct system is connectable to common filling means. The fluid substances may be fed to the common filling means by known means, preferably comprising at least one storage tank. Preferably the filling means comprises means for dosing an amount of substance. Such dosing means for fluid substances are known in the art. For transporting a substance from a tank to a common duct, the filling means may comprise known transporting means like a pump and valve means to establish and close off the connection between a tank and the common duct, allowing feeding alternating a different desired substance to the moulds. Proper construction and running such transport and dosing systems are common and known techniques in the art.

The apparatus further comprises means for taking pieces of frozen substance from the moulds. In practice this will be in an upward direction after these pieces have been formed in the moulds after cooling. These means can also be applied for positioning pegs into the moulds.

The construction of such means is common in the art and they usually are systems of pneumatic or hydraulic nature and provide functions like grabbing, holding and moving, rotating or positioning and releasing objects.

In the new apparatus the means will allow grabbing and positioning pegs into the moulds and, by grabbing the same pegs, moving frozen substances in a vertical direction to allow removing the frozen confections from the moulds for further handling like packaging. Systems for this further handling are known in the art and do not form part of this invention.

In the embodiment with one set of moulds the shape of the moulds is that of a desired frozen confection.

The substance introduced into a mould must be frozen. Means and techniques for cooling the type of moulds concerned are known per se. Contacting the moulds with a low temperature liquid, e.g. by immersing the moulds in a freezing liquid or spaying the outer side of the moulds with a freezing substance, is a common technique that can be combined with the apparatus of the invention. However, preferably the moulds itself comprise means for cooling. Preferably these means comprise cooling medium ducts or a closed cooling medium plenum, into which the moulds extend, allowing a cooling medium to contact the mould walls and bottom. The cooling ducts can be running along the outer side of the moulds or the moulds can be double-walled, cooling medium flowing between the walls. The moulds preferably are made of a highly heat conductive material, e.g. a metal.

The inner surface of the moulds can be coated to prevent the pieces of frozen substance to become fixed frozen to the inner surface. Without such coating, and even with it, pieces of frozen substance may be expected to at least locally stick to the wall. To avoid damaging the frozen confections when lifting or removing these, their outer surface must become loose from the mould walls and bottom. In practice this requires the local temperature to be above the freezing point of the substance. In order to promote a fast release of the pieces from the moulds, heating can be applied to the moulds in an analogous way as described above for cooling. To this end the apparatus preferably comprises also means for heating the moulds. Heating can be applied using a separate duct system but preferably the same duct system as for the cooling is used for heating the moulds. To this end the apparatus then further contains proper valve systems to alternating connecting a heating medium and a cooling medium to the part of the ducts in contact with mould walls and bottom.

Cooling and heating medium are provided by external sources that are known per se.

The apparatus according to the invention allows economically feasible production of frozen confections having improved hygienic quality, flavour and appearance. It is particularly fit to carry out the process of the invention as described above.

1. Process for producing frozen confections, comprising the steps of:
a. filling a mould, having a mould bottom, mould walls and an open mould top, with a substance to be frozen;
b. freezing said substance into a frozen confection; and
c. releasing said frozen confection from the mould;
characterized in that the mould is filled through at least one opening in the lower part of the mould walls or in the mould bottom.

2. Process according to claim 1, wherein the mould is filled by forcing the substance through the at least one opening in the lower part of the mould walls or in the mould bottom.

3. Process according to claim 2, wherein before or during step b, a peg is positioned in the mould extending into the substance to be frozen.

4. Process according to claim 3, wherein a number of moulds are filled at the same time from a common substance duct connected to the at least one opening in the lower part of the mould walls or in the mould bottom.

5.-8. (canceled)

9. Process according to claim 2, wherein a number of moulds are filled at the same time from a common substance duct connected to the at least one opening in the lower part of the mould walls or in the mould bottom.

10. Process according to claim 1, wherein a number of moulds are filled at the same time from a common substance duct connected to the at least one opening in the lower part of the mould walls or in the mould bottom.

11. Process according to claim 1, wherein before or during step b, a peg is positioned in the mould extending into the substance to be frozen.

12. Process for producing frozen confections, comprising the steps of:
a. filling a number of moulds at the same time with a substance to be frozen, the moulds having a mould bottom, mould walls, and an open mould top;
b. freezing said substance into a frozen confection; and
c. releasing said frozen confection from the moulds;
characterized in that the moulds are filled through at least one opening in the lower part of the mould walls or in the mould bottom from a common duct system connecting the at least one hole of all moulds.

13. Apparatus for producing frozen confections comprising at least one set of moulds, each having a mould bottom, mould walls, and an open mould top, the mould bottoms being positioned in one plane, the moulds extending from that plane and each mould having at least one fill opening in the lower part of its walls or in its bottom, the at least one opening being connected to a common duct system connectable to common filling means, means for cooling the moulds to form pieces of frozen substance in the moulds, and means for taking pieces of frozen substance from the mould.

14. Apparatus according to claim 13, the common filling means comprising means for applying pressure on the duct system and means for dosing a desired amount of substance to the at least one set of moulds.

15. Apparatus according to claim 14, further comprising means to heat the moulds.

16. Apparatus according to claim 13, further comprising means to heat the moulds.
